(19) United States
(12) Patent Application Publication
(10) Pub. No.: US 2007/0007250 A1
(43) Pub. Date: Jan. 11, 2007

(54) Sealing edge cross-sectional profiles to allow brazing of metal parts directly to a metallized ceramic for vacuum interrupter envelope construction

(75) Inventor: Wangpei Li, Horseheads, NY (US)

Correspondence Address: Martin J. Moran;Eaton Electrical Inc., Technology & Quality Center, 170 Industry Drive, RIDC Park West, Pittsburgh, PA, 15275-1032, US

(73) Assignee: Eaton Corporation

(21) Appl. No.: 11/177,899

(22) Filed: Jul. 8, 2005

(51) Int. Cl. H01H 33/66

(52) U.S. Cl. 218/134

(57) ABSTRACT

A metal component for a vacuum chamber, such as an end cap or external center shield, having a sealing edge portion with a cross-sectional wall thickness that is gradually reduced from the thickness of the metal component body to a more narrow sealing surface where the metal component is structured to be joined with a ceramic component.

### BACKGROUND OF THE INVENTION

1. Field of the Invention

This invention relates to vacuum interrupters and, more specifically, to a method for coupling the metal end caps and external center shields of the vacuum chamber to the ceramic chamber body of the vacuum interrupter.

2. Background Information

Circuit breakers provide protection for electrical systems from electrical fault conditions such as current overloads, short circuits, and low level voltage conditions. Typically, circuit breakers include a spring-powered operating mechanism which opens electrical contacts inside a vacuum interrupter to interrupt the current flowing through the conductors in an electrical system in response to abnormal conditions. Vacuum interrupters include separable main contacts disposed within an insulated and hermetically sealed vacuum chamber. The vacuum chamber typically includes one or more sections of ceramics for electrical insulation and one or more metal components to form an envelope in which a vacuum may be drawn. The metal components are easily formed and provide a structural strength lacking in the ceramic components. The ceramic shell is typically cylindrical; however, other cross-sectional shapes may be used. The metal components typically include two end caps and, where there are multiple ceramic sections, one or more external center shields disposed between the ceramic sections. The main contacts are connected to the external circuit to be protected by the circuit breaker by electrode stems, typically an elongated member made from high purity copper. The contact and the stem are identified collectively as an electrode. Generally, one of the contacts is fixed relative to the vacuum chamber as well as to the external circuit. The other contact is movable relative to the vacuum chamber. The movable contact is driven by the circuit breaker operating mechanism and the motion of the operating mechanism is transferred inside the vacuum interrupter chamber by a coupling that includes a sealed metallic bellows. The electrodes, end caps, bellows, ceramic shell(s), and the external center shield(s), if any, are joined together to form an envelope capable of maintaining a vacuum at a suitable level for an extended period of time. However, achieving such a leak-tightness in all the joints is difficult to achieve due to the difference in the coefficients of thermal expansion (CTE) of the materials, especially between the ceramic and the metals. That is, due to the different rates of thermal expansion and contraction between the metal and ceramic components, the joints between the components are subjected to stress. Typically, a metal such as steel has a higher coefficient of thermal expansion than a ceramic. Thus, upon cooling from the brazing temperature at which these components are joined together, the steel will contract at a faster rate and/or to a greater degree than the ceramic; this will result in stress in the ceramic at the joint. For this reason, the cross sectional wall thickness of the metal part, where it is to be joined directly to the ceramic, is very limited, in the order of millimeters. Even so this stress from CTE mismatch is still a concern. One method of further relieving the stress is to use a metal having a CTE more closely matching that of the ceramic, such as, but not limited to, a copper alloy, or a nickel-iron alloy, for the metal parts of end caps and external center shields to be joined to the ceramic. Another method of relieving the stress is to use a more forgiving, lower yielding strength metal, such as, but not limited to, copper, for the end caps and external center shields. These end caps and external center shields, however, were limited in size as they, due to limit on material thickness, lacked sufficient strength or were too expensive for, larger vacuum chambers.

The end caps were, typically, shaped as a cup. That is, the end cap had a generally planar member with a cross-sectional shape corresponding to the shape of the chamber body, as well as a depending, generally perpendicular sidewall. For vacuum circuit interrupters having vacuum chambers with a diameter of about four inches or larger, the end caps were often made out of two separate metals. That is, the planar portion of the end cap, identified as the “end plate”, was made out of a thick-wall steel, while the sidewall portion, identified as the “seal cup,” was made out of a thin-wall material with either a low yield strength or a coefficient of thermal expansion matching that of the ceramic. Again, materials such as, but not limited to, copper, a copper alloy, or a nickel-iron alloy were used for the seal cup. Thus, the seal cup served as the sealing edge to be directly bonded to the ceramic chamber body, while the steel end plate provided sufficient mechanical strength. The disadvantage to this solution is that the seal cup needed to be coupled to the end plate thereby creating an additional joint with the potential for leakage, and increasing the cost of the end cap. A similar solution was to use a clad material, such as, but not limited to, steel clad with a copper alloy or nickel alloy. To avoid a significant coefficient of thermal expansion mismatch, the steel was removed from the sidewall sealing edge portion of the end cap thereby allowing the copper or nickel alloy to be bonded to the ceramic chamber body. This method was also expensive.

Another method utilized a steel end cap and a copper shim. The copper shim was disposed between the end cap sealing edge and the ceramic chamber body thereby allowing the end cap to be indirectly brazed to the ceramic chamber body. Alternatively, a steel end cap could have a sidewall sealing edge trimmed down to a thickness of about 0.8 mm and a height between about 4 to 12 mm, and vacuum annealed, so that it can be brazed directly to the ceramic chamber body. These methods were also difficult and added additional costs to the manufacture of the end cap.

Attempts were made to use a non-annealed stainless steel end cap having a “stepped down” sidewall sealing edge. That is, the stainless steel end cap had a sidewall sealing edge that included a single-step reduction of wall thickness to about 0.030 inch, where it is to be brazed to the ceramic. To minimize joint stress from CTE mismatch a minimum height of the reduced wall-thickness section of the sealing edge has to be at least 4 mm as measured perpendicularly away from the joint to the ceramic. This solution had the disadvantage in that the single step thickness reduction significantly reduces the mechanical strength of the seal cup especially under a compressive load. For strength consideration the wall thickness of this reduced-thickness section of the sealing edge typically could not be smaller than 0.020 inch.

Similar to their applications on the end caps, the same ideas have been tried on the external center shield of the vacuum interrupter chamber body. That is, external center shields have been made with two materials, which were either joined together or clad together, with the first material providing the strength and the second material providing the sealing edge to the ceramic. The most commonly practiced method is to make the external center shield out of a high purity copper, copper alloy, or nickel alloy, with either a uniform wall thickness or a single step cut to reduce the wall thickness near the sealing edge where it is to be brazed directly to the ceramic part of the vacuum interrupter chamber. These external center shields either are expensive or lack the necessary strength.

There is, therefore, a need for an end cap or an external center shield for a vacuum circuit breaker vacuum chamber that does not include a single step wall thickness reduction in the sealing edge.

There is a further need for an end cap or an external center shield for a vacuum interrupter chamber body that may be made from a common stainless steel or other low cost iron based steels or alloys that can be brazed directly to the ceramic part(s) of the chamber body.

There is a further need for an end cap or an external center shield for a vacuum circuit breaker vacuum chamber that may be brazed directly to the ceramic part(s) of the chamber body and yet without a single step wall thickness reduction in the sealing edge so that the mechanical strength of the chamber body is not compromised.

There is a further need for an end cap or an external center shield for a vacuum circuit breaker vacuum chamber that is compatible with existing equipment.

### SUMMARY OF THE INVENTION

These needs, and others, are met by the present invention which provides a metal component for a vacuum chamber, such as an end cap or external center shield, having a sealing edge portion with a cross-sectional wall thickness that is gradually reduced from the thickness of the metal component body to a more narrow sealing surface where the metal component is structured to be joined with a ceramic component. In this configuration, the steel end cap or external center shield may be brazed directly to a ceramic chamber body without the use of a shim or the use of a portion formed from a copper, a copper alloy, or a nickel alloy. The gradual increase of the wall thickness can be achieved using a number of cross-sectional profiles, such as, but not limited to, a linear profile, a non-linear profile, or a multi-discrete-step profile. The change in thickness may be affected by changing either or both the outer and the diameter of the inner surfaces of the sealing edge portion.

### BRIEF DESCRIPTION OF THE DRAWINGS

A full understanding of the invention can be gained from the following description of the preferred embodiments when read in conjunction with the accompanying drawings in which:

FIG. 1 is a side view of a circuit breaker.

FIG. 2 is a cross-sectional view of a vacuum interrupter chamber with an external center shield.

FIG. 3 is a cross-sectional view of an end cap.

FIG. 4 is a cross-sectional view of an alternative embodiment of an end cap.

FIG. 5 is a cross-sectional view of an alternative embodiment of an end cap.

FIG. 6 is a cross-sectional view of an alternative embodiment of an end cap. FIG. 6A is a detail view of the embodiment shown in FIG. 6.

FIG. 7 is a cross-sectional view of an alternative embodiment of an end cap.

FIG. 8 is a cross-sectional view of an alternative embodiment of an end cap.

FIG. 9 is a cross-sectional view of an external center shield.

FIG. 10 is a cross-sectional view of an alternative embodiment of an external center shield.

FIG. 11 is a cross-sectional view of an alternative embodiment of an external center shield.

### DESCRIPTION OF THE PREFERRED EMBODIMENTS

As used herein, words and phrases describing the shape or profile of the sealing edge, such as, but not limited to, “equilateral trapezoid,” refer to the shape or profile when viewed as a cross-section, as shown in the Figures. It is understood that the sealing edge is actually a torus, in the preferred embodiment, or another closed perimeter shape.

As used herein, the phrase “sealing edge” refers to the edge of a metal end cap or an external center shield that is coupled to a ceramic portion of a vacuum interrupter chamber body. While certain shapes and profiles of sealing edges are shown in the Figures as being associated only with either an end cap or an external center shield, it is understood that any particular sealing edge shape or profile may be incorporated into either an end cap or an external center shield.

As used herein, the phrase “gradual reduction in . . . thickness” means a change in thickness over a length that occurs in two or more steps, linearly, and/or over a curve.

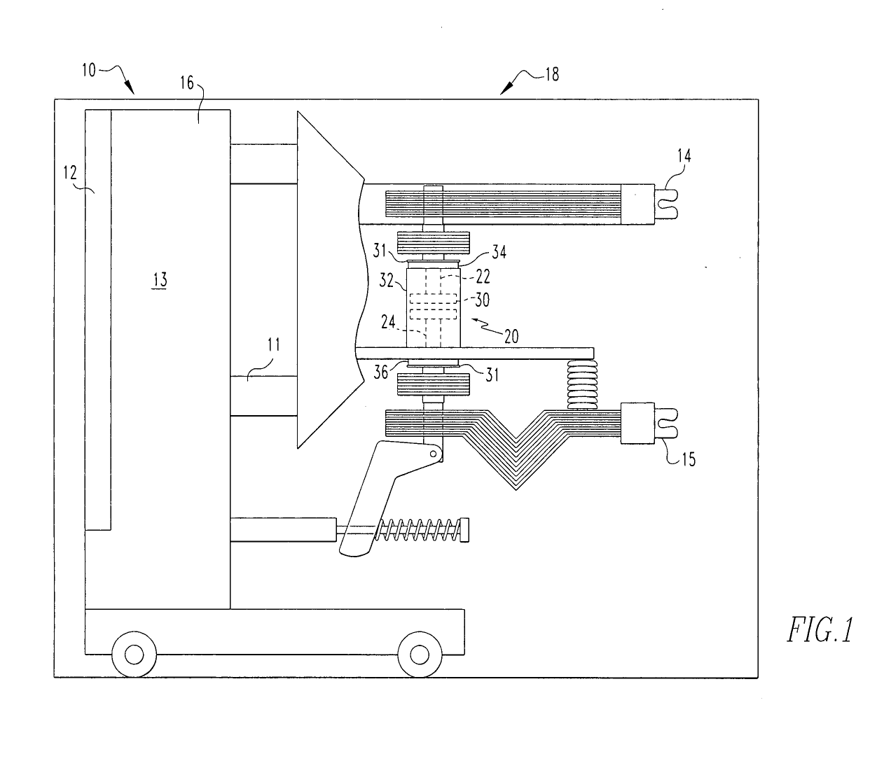

Referring to FIG. 1, there is illustrated a circuit breaker 10 incorporating a vacuum interrupter assembly 20. The circuit breaker 10, preferably, includes a front panel 12 which has controls for manually operating the circuit breaker 10 and changing the state of the contacts to either an open or closed condition and a circuit breaker housing 13. The circuit breaker 10 has an upper and a lower terminal 14, 15, and may have additional terminals not visible in FIG. 1, which can be connected to a line-in (not shown) and a load (not shown). The circuit breaker 10 has a low voltage portion 16 coupled to the front panel 12 and a high voltage portion 18 including the vacuum interrupt assembly 20. The vacuum interrupter assembly 20 includes a vacuum chamber 30 which encloses a pair of separable contacts 22, 24.

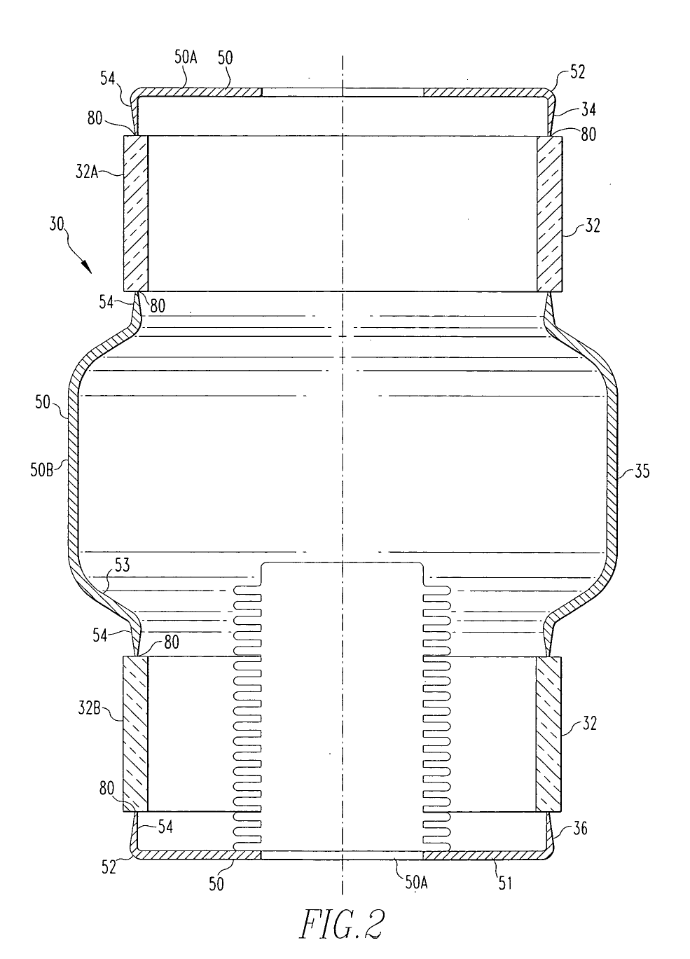

The vacuum chamber 30 is an assembly that includes at least one metal component 31 and at least one electrically insulating hollow body 32 made from a material such as, but not limited to, a ceramic. The metal component 31 may be either an end cap 34, 36 or an external center shield 35. Each metal component 31 has at least one sealing edge 54, described below. The metal component sealing edge 54 is structured to be coupled to the insulating hollow body 32. Typically, the ends of the hollow body 32 are closed by a pair of end caps 34, 36. As shown in FIG. 2, the vacuum chamber 30 may include multiple electrically insulating hollow bodies 32A, 32B. The multiple electrically insulating hollow bodies 32A, 32B are coupled to each other by at least one external center shield 35. As described in detail below, the external center shield 35 is an elongated hollow body having two sealing edges 54 located at opposing ends. Similar to the embodiment having a single hollow body 32, the vacuum chamber 30 having multiple electrically insulating hollow bodies 32A, 32B is also closed by a pair of end caps 34, 36. One end cap 34, 36 is coupled to each hollow body 32A, 32B opposite the side of the hollow body 32A, 32B coupled to the external center shield 35. The vacuum chamber 30 may also be configured with three or more hollow bodies 32 (not shown). In such an embodiment, each end of a hollow body 32 that is not the outer end of the vacuum chamber 30 is coupled to the external center shield 35, or alternatively, to each other with a metal ring sandwiched in between, which serves as the flange securing an internal center shield (not shown). The ends of the two hollow bodies 32A, 32B located at the outer ends of the vacuum chamber 30 are coupled to end caps 34, 36. The at least one hollow body 32 and at least one external center shield 35 have a cross-sectional shape which is, preferably, symmetric about the vacuum chamber 30 longitudinal axis and, more preferably, is a circle. That is, the preferred shape of the vacuum chamber 30 is a hollow cylinder.

The sealing edge 54 used to couple a metal component 31 to a insulating hollow body 32 may be used with either an end cap 34, 36 or an external center shield 35. Accordingly, it is understood that although the following description addresses multiple sealing edge 54 configurations in relation to an end cap 34, 36, the same sealing edge 54 configurations may be used with an external center shield 35. The one notable difference between a sealing edge 54 used on an end cap 34, 36 as compared to a sealing edge 54 used on an external center shield 35 is that the sealing edge 54 used on an end cap 34, 36 extends generally perpendicular to the body 50 of an end cap 34, 36, whereas the sealing edge 54 used on an external center shield 35 extends generally parallel to the body 50 of the external center shield 35.

As shown in FIGS. 3-8, the metal component 31, that is, each of the end caps 34, 36, or external center shield 35, includes a body 50, a transitional portion 52 and a sealing edge 54. The metal component body 50 is structured to be coupled to the hollow body 32. As noted above, the vacuum chamber 30 components are preferably circular and, as such, the shape of the metal component body 50 and sealing edge 54 will be described in terms relating to a circular shape, such as an “inner diameter” and an “outer diameter.” It is understood that if the vacuum chamber 30 is of a shape other than a circle, the phrase “inner diameter” is equivalent to “inner side” and “outer diameter” is equivalent to “outer side.” The sealing edge 54 has an inner surface 56 defined by the sealing edge 54 inner diameter and an outer surface 58 defined by the sealing edge 54 outer diameter. The distal tip of the sealing edge 54 is a sealing surface 80 that is generally flat and extending in a plane substantially perpendicular to the longitudinal axis of the sealing edge 54. The sealing surface 80 is structured to be directly coupled to the hollow body 32. For the end caps 34, 36, the body is a generally planar plate 51. For the external center shield 35, the body 50B is an elongated, hollow tube 53. For the end caps 34, 36, the transitional portion 52 bends generally ninety degrees relative to the plate 51. For the external center shield 35, the transitional portion 52 is a continuation of the tube 53 and may be, essentially, ignored. The end caps 34, 36 and the external center shield 35 are, preferably, made from a single type of metal. More preferably the end caps 34, 36 and the external center shield 35 are formed from a metal selected from the group including: stainless steels, and low cost iron based steels or alloys. Additionally, the end caps 34, 36, preferably, do not include copper or nickel.

The sealing edge 54 has a cross-sectional wall thickness that is increased further away from the sealing surface 80. That is, the thickness of the sealing edge 54 is thinnest where the metal component 31 is joined to the hollow body 32. The cross-sectional wall thickness of the body 50 is between about 0.240 and 0.060 inch and more preferably, about 0.120 inch. The cross-sectional wall thickness at the sealing surface 80 affects the stress on the joint from CTE mismatch between the hollow body 32 and the metal component 31 and, generally, is preferred to be small. The cross-sectional wall thickness at the sealing surface 80 also depends on the requirement on the mechanical strength of the vacuum chamber 30. The cross-sectional wall thickness at the sealing surface 80 is between about 0.05 and 0.01 inch and, more preferably, about 0.02 inch without significantly compromising the mechanical strength of vacuum chamber 30. In the broadest embodiment of this invention is a sealing edge 54 that provides a gradual reduction in cross-sectional wall thickness along the sealing edge 54 between the body 50, or transitional portion 52, and the sealing surface 80, so that the sealing surface 80 is the thinnest portion of the sealing edge 54.

In one embodiment, shown in FIG. 3, the sealing edge 54 has a cross-sectional profile of an equilateral trapezoid. That is, the gradual reduction of the sealing edge 54 cross-sectional thickness toward the sealing surface 80 takes place in a generally straight line on both the diameter of the inner surface 56 and the diameter of the outer surface 58. To achieve this shape, the diameter of the inner surface 56 becomes steadily, that is, linearly, smaller as measured from a point adjacent to the sealing surface 80 to a point adjacent to the end cap body 50A or transition portion 52. Conversely, the diameter of the outer surface 58 becomes steadily larger as measured from a point adjacent to the sealing surface 80 to a point adjacent to the end cap body 50A or transition portion 52.

In another embodiment, shown in FIG. 4, the gradual reduction of the sealing edge 54 cross-sectional thickness toward the sealing surface 80 takes place only on the diameter of the outer surface 58. In this embodiment, the diameter of the outer surface 58 becomes steadily, that is, linearly, larger as measured from a point adjacent to the sealing surface 80 to a point adjacent to the end cap body 50A or transition portion 52. Conversely, the diameter of the inner surface 56 stays generally flush with the inner edge of the sealing surface 80.

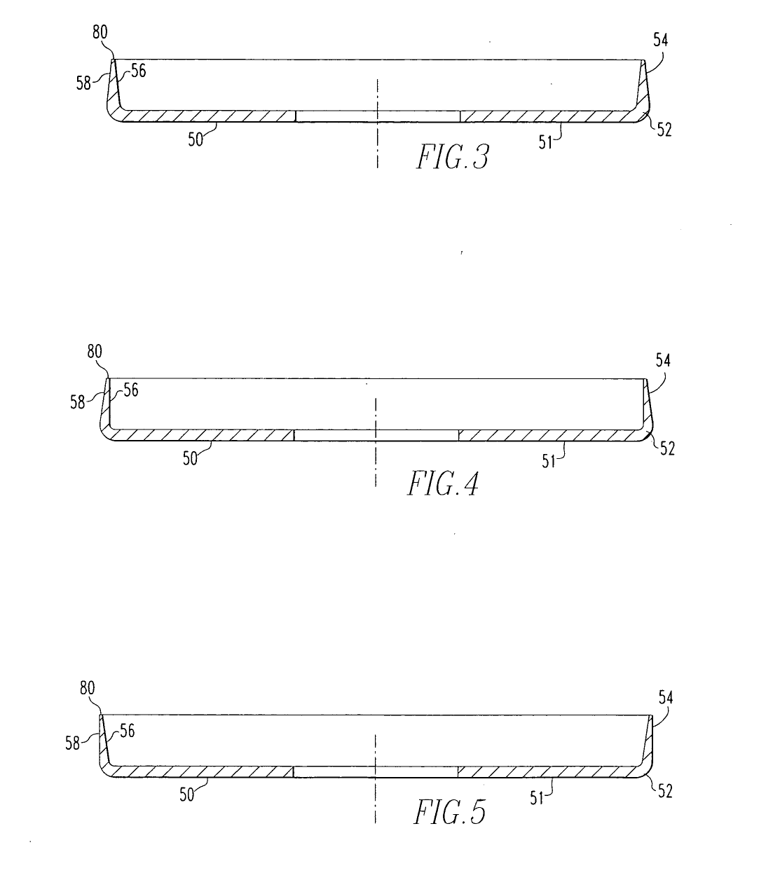

In another embodiment, shown in FIG. 5, the gradual reduction of the sealing edge 54 cross-sectional thickness toward the sealing surface 80 takes place only on the diameter of the inner surface 56. That is, the diameter of the inner surface 56 becomes steadily, that is, linearly, smaller as measured from a point adjacent to the sealing surface 80 to a point adjacent to the end cap body 50A or transition portion 52. Conversely, the diameter of the outer surface 58 stays generally flush with the outer edge of the sealing surface 80.

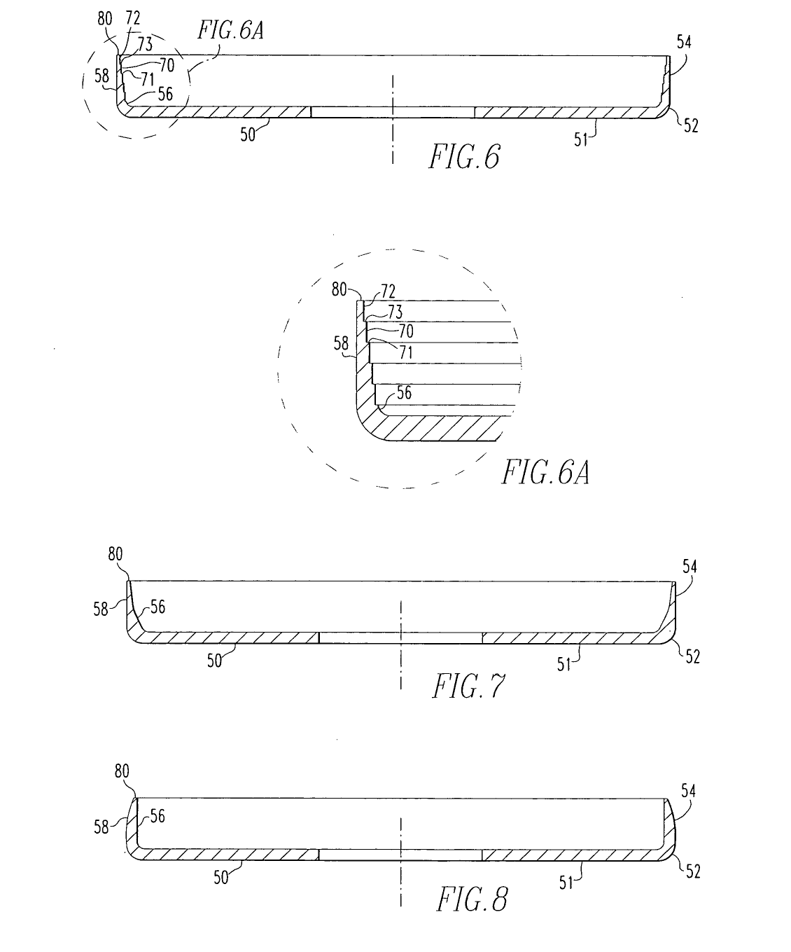

In yet another embodiment, shown in FIG. 6, the gradual reduction of the sealing edge 54 cross-sectional thickness toward the sealing surface 80 takes place only on the diameter of the inner surface 56, in at least two discrete steps 70, 72. That is, the inner surface 56 includes at least two steps 70, 72 that have surfaces 71, 73 that are generally perpendicular to the inner surface 56. Conversely, the diameter of the outer surface 58 stays generally flush with the outer edge of the sealing surface 80.

In another embodiment, shown in FIG. 7, the gradual reduction of the sealing edge 54 cross-sectional thickness toward the sealing surface 80 takes place only on the diameter of the inner surface 56, in the form of a smooth and non-linear, that is, non-stepped and curved, decrease in the diameter of the inner surface 56. That is, the inner surface 56 is curved. The diameter of the outer surface 58 stays generally flush with the outer edge of the sealing surface 80.

In yet another embodiment, shown in FIG. 8, the gradual reduction of the sealing edge 54 cross-sectional thickness toward the sealing surface 80 takes place only on the diameter of the outer surface 58, in the form of a smooth and non-linear, that is, non-stepped and curved, increase in the diameter of the outer surface 58. That is, the outer surface 58 is curved. The diameter of the inner surface 56 stays generally flush with the inner edge of the sealing surface 80.

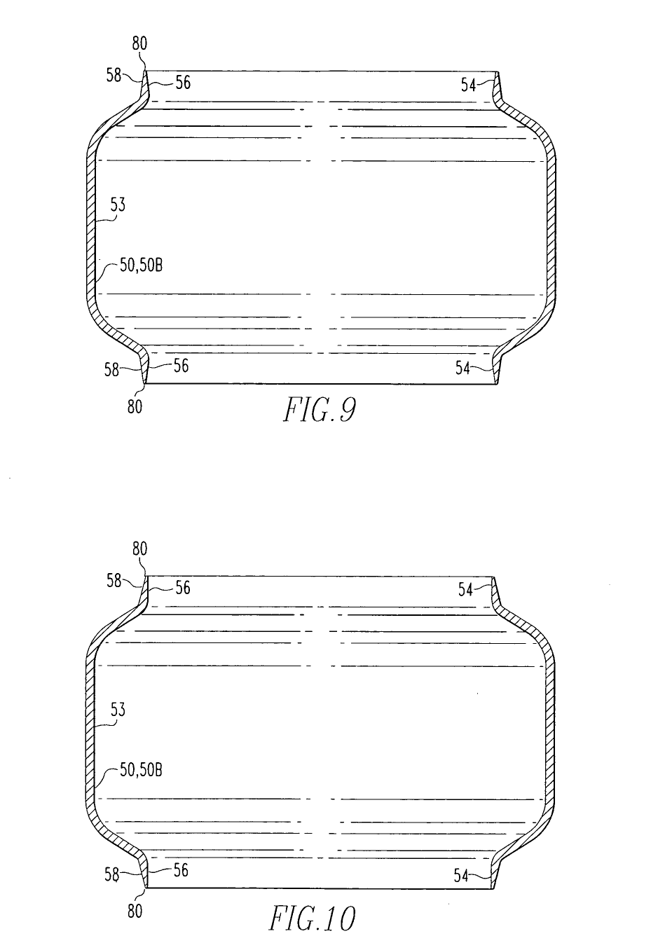

Each type of sealing edge 54 described above and shown in FIGS. 3-8 as being part of an end cap 34, 36 may also be incorporated into an external center shield 35. For example, as shown in FIG. 9, the external center shield body 50B includes a sealing edge 54 having a cross-sectional profile of an equilateral trapezoid, substantially similar to the embodiment of an end cap 34 described above and shown in FIG. 3. That is, the gradual reduction of the sealing edge 54 cross-sectional thickness toward the sealing surface 80 takes place in a generally straight line on both the diameter of the inner surface 56 and the diameter of the outer surface 58. To achieve this shape, the diameter of the inner surface 56 becomes steadily, that is, linearly, smaller as measured from a point adjacent to the sealing surface 80 to a point adjacent to the end cap body 50A or transition portion 52. Conversely, the diameter of the outer surface 58 becomes steadily larger as measured from a point adjacent to the sealing surface 80 to a point adjacent to the end cap body 50A or transition portion 52.

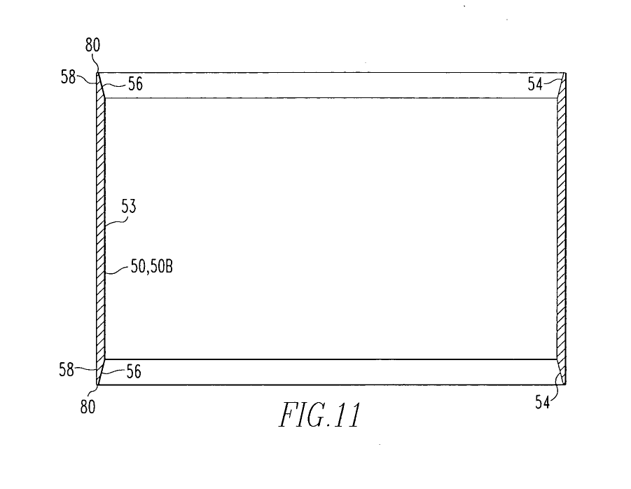

By way of another example, as shown in FIG. 10, an external center shield body 50B, includes a sealing edge 54 wherein the gradual increase of the wall thickness away from the sealing surface 80 takes place only on the diameter of the outer surface 58. In this embodiment, which is substantially similar to the embodiment of an end cap 34 described above and shown in FIG. 4, the diameter of the outer surface 58 becomes steadily, that is, linearly, larger as measured from a point adjacent to the sealing surface 80 to a point adjacent to the end cap body 50A or transition portion 52. Conversely, the diameter of the inner surface 56 stays generally flush with the inner edge of the sealing surface 80.

By way of further example, as shown in FIG. 11, an external center shield body 50B, includes a sealing edge 54 wherein the gradual increase of the wall thickness away from the sealing surface 80 takes place only on the diameter of the inner surface 56. In this embodiment, which is substantially similar to the embodiment of an end cap 34 described above and shown in FIG. 5, the diameter of the inner surface 56 becomes steadily, that is, linearly, smaller as measured from a point adjacent to the sealing surface 80 to a point adjacent to the end cap body 50A or transition portion 52. Conversely, the diameter of the outer surface 58 stays generally flush with the outer edge of the sealing surface 80.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

What is claimed is:

1. A metal component for a vacuum chamber of a circuit breaker, said vacuum chamber having at least one electrically insulating hollow body, said metal component comprising:
a body structured to be coupled to said hollow body;
a sealing edge extending from said body, said sealing edge having a distal tip with a sealing surface; and
said sealing edge has a gradual reduction in cross-sectional thickness between the body and the sealing surface, so that said sealing surface is the thinnest portion of the sealing edge.

2. The metal component of claim 1 wherein:
said sealing edge is generally circular having an outer surface defined by the sealing edge outer diameter and an inner surface defined by the sealing edge inner diameter; and
said gradual reduction in cross-sectional thickness of the sealing edge between the body and the sealing surface is created by said inner diameter becoming smaller as measured from a point adjacent to said sealing surface to a point adjacent to said body and said outer diameter remaining generally flush with the outer surface of said sealing surface.

3. The metal component of claim 2 wherein said inner diameter becomes linearly smaller.

4. The metal component of claim 2 wherein said inner surface is curved.

5. The metal component of claim 2 wherein said inner surface includes at least two steps that have surfaces that are generally perpendicular to said inner surface.

6. The metal component of claim 2 wherein said body is an end cap.

7. The metal component of claim 2 wherein said body is an external center shield.

8. The metal component of claim 1 wherein:
said sealing edge is generally circular having an outer surface defined by the sealing edge outer diameter and an inner surface defined by the sealing edge inner diameter; and
said gradual reduction in cross-sectional thickness of the sealing edge between the body and the sealing surface is created by said outer diameter becoming larger as measured from a point adjacent to said sealing surface to a point adjacent to said body and said inner diameter remaining generally flush with the inner surface of said sealing surface.

9. The metal component of claim 8 wherein said outer diameter becomes linearly larger.

10. The metal component of claim 8 wherein said outer surface is curved.

11. The metal component of claim 8 wherein said body is an end cap.

12. The metal component of claim 8 wherein said body is an external center shield.

13. The metal component of claim 1 wherein:
said sealing edge is generally circular having an outer surface defined by the sealing edge outer diameter and an inner surface defined by the sealing edge inner diameter; and
said gradual reduction in cross-sectional thickness of the sealing edge between the body and the sealing surface is created by said outer diameter becoming larger as measured from a point adjacent to said sealing surface to a point adjacent to said body and said inner diameter becoming smaller as measured from a point adjacent to said sealing surface to a point adjacent to said body.

14. The metal component of claim 13 wherein said outer diameter becomes linearly larger and said inner diameter becomes linearly smaller.

15. The metal component of claim 13 wherein said body is an end cap.

16. The metal component of claim 13 wherein said body is an external center shield.

17. A circuit breaker comprising:
a low voltage portion;
a high voltage portion coupled to said low voltage portion and having a vacuum chamber;
said vacuum chamber having at least one electrically insulating hollow body, and a metal component;
said metal component having a body with a sealing edge;
said metal component body structured to be coupled to said hollow body;
said sealing edge extending from said body, said sealing edge having a distal tip with a sealing surface; and
said sealing edge having a gradual reduction in cross-sectional thickness between the body and the sealing surface, so that said the sealing surface is the thinnest portion of the sealing edge.

18. The metal component of claim 17 wherein:
said sealing edge is generally circular having an outer surface defined by the sealing edge outer diameter and an inner surface defined by the sealing edge inner diameter; and
said gradual reduction in cross-sectional thickness of the sealing edge between the body and the sealing surface is created by said inner diameter becoming smaller as measured from a point adjacent to said sealing surface to a point adjacent to said body and said outer diameter remaining generally flush with the outer surface of said sealing surface.

19. The metal component of claim 17 wherein:
said sealing edge is generally circular having an outer surface defined by the sealing edge outer diameter and an inner surface defined by the sealing edge inner diameter; and
said gradual reduction in cross-sectional thickness of the sealing edge between the body and the sealing surface is created by said outer diameter becoming larger as measured from a point adjacent to said sealing surface to a point adjacent to said body and said inner diameter remaining generally flush with the inner surface of said sealing surface.

20. The metal component of claim 17 wherein:
said sealing edge is generally circular having an outer surface defined by the sealing edge outer diameter and an inner surface defined by the sealing edge inner diameter; and
said gradual reduction in cross-sectional thickness of the sealing edge between the body and the sealing surface is created by said outer diameter becoming larger as measured from a point adjacent to said sealing surface to a point adjacent to said body and said inner diameter becoming smaller as measured from a point adjacent to said sealing surface to a point adjacent to said body.
